(19) United States
(12) Patent Application Publication
(10) Pub. No.: US 2005/0012718 A1
(43) Pub. Date: Jan. 20, 2005

(54) Wireless pointing device with power-supplying module

(76) Inventor: Xing-Zhi Lin, Taipei (TW)

Correspondence Address: BACON & THOMAS, PLLC, 625 SLATERS LANE, FOURTH FLOOR, ALEXANDRIA, VA, 22314, US

(21) Appl. No.: 10/620,334

(22) Filed: Jul. 17, 2003

(51) Int. Cl. G09G 5/08

(52) U.S. Cl. 345/163

(57) ABSTRACT

A wireless input device, such as a pointing device, includes an opening on its body, and a power-supply module. The module has a carrier at one side that can accommodate at least one battery, and is arranged such that the power-supply module can be directly inserted into the opening to power the pointing device. When the insertion is completed, a cover at the other side of the module can constitute a smooth outline of the body. By the structure mentioned above, a user can replace the battery easily.

### BACKGROUND OF THE INVENTION

1. Field of the Invention

The present invention relates to a pointing device, and in particular, to a wireless pointing device where the power-supply system is integrated into a cartridge-like module.

2. Description of the Prior Art

A wireless input device always operates with batteries contained therein. U.S. Pat. Nos. 6,411,281 and 6,225,981 disclose a wireless mouse where a battery compartment is located on the top housing of the mouse. The batteries within the compartment can be accessed by removing a cover from the top housing. However, the battery-on-top design is contrary to the traditional one which is located on the lower housing and can be accessed by opening a lid under the mouse. The battery-on-top design either causes the top housing to be complicated in structure so as to accommodate battery therein, weakens the strength of the cover, or makes the appearance of the wireless computer mouse less attractive.

Another battery-on-top design is shown in China publication No. CN2485718Y. A generally U-shaped button plate is embedded in the upper housing of a mouse. Each of the front ends of the button plate has a container for accommodating a battery within the housing, so that the battery will be moved up and down in association with finger clicking by a user. However, that design makes it difficult to operate the mouse, and complicates replacement of the battery inside the housing.

### SUMMARY OF THE DISCLOSURE

It is an object of the present invention to provide an input device that can effectively reload a battery into the input device.

It is another object of the present invention to provide an input device having a more pleasing appearance.

It is yet another object of the present invention to provide an input device which can be minimized in size easily.

In order to accomplish the objects of the present invention, the present invention provides a power-supply module in the form of a cartridge that can be directly inserted into an opening of an input device.

### BRIEF DESCRIPTION OF THE DRAWINGS

FIG. 1 is a perspective view of an input device according to a preferred embodiment of the present invention.

FIG. 2 is an exploded view of the input device of the preferred embodiment.

FIG. 3A is another perspective view of the input device of the preferred embodiment, in which the power-supply module has been removed from the housing.

FIG. 3B is a bottom view of the power-supply module of the preferred embodiment.

FIG. 4 is a rear sectional view of the input device of the preferred embodiment.

FIG. 5 is a simplified diagram showing the location of the power-supply within the housing of the preferred input device.

### DETAILED DESCRIPTION OF THE PREFERRED EMBODIMENTS

The following detailed description is of the best presently contemplated mode of carrying out the invention. This description is not to be taken in a limiting sense, but is made merely for the purpose of illustrating general principles of embodiments of the invention. The scope of the invention is best defined by the appended claims.

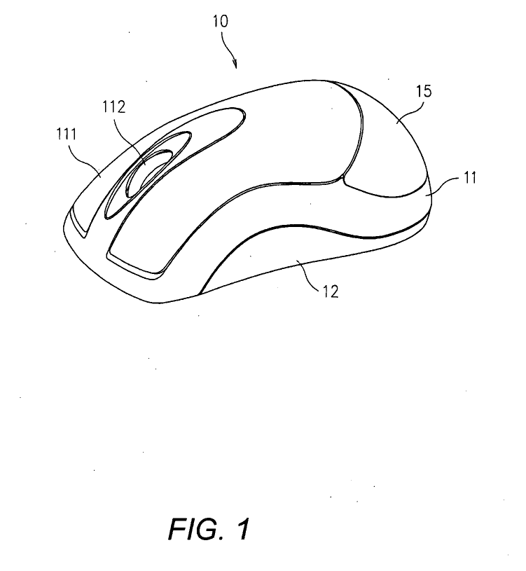

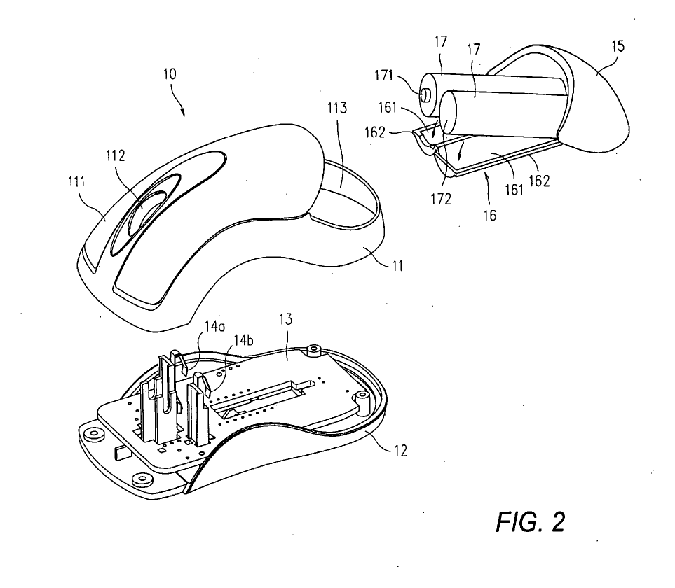

FIGS. 1 and 2 show a wireless pointing or input device, e.g. a computer mouse, trackball, game pad, joystick . . . etc. Hereinafter, a wireless computer mouse is illustrated for further explanation. The pointing device has a main body 10 which includes a upper housing 11 and a lower housing 12, where the upper and lower housing 11, 12 can be combined together by using a screw or the like. The lower housing 12 has a printed circuit board (PCB) 13 having metal plate 14a, 14b thereon. The upper housing 10 has a button plate 111 and roller 112 for carrying-out functions of the mouse.

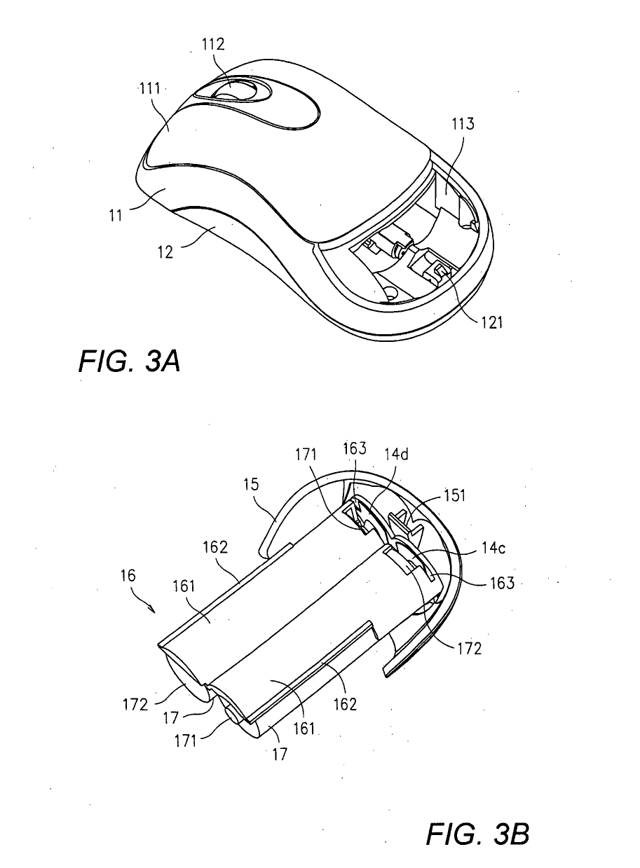

The upper housing 11 has an opening 113 at the rear side, and the opening 113 allows a power-supply module to be accommodated therein. The power-supply module comprises a cover 15 at one end and a carrier 16 at the other end. The carrier 16 can be inserted into the opening 113 such that the cover 15 can further constitute a smooth outline of the upper housing 11. The cover 15 can be fixed to the upper housing by using any known fixing element. Referring to FIGS. 3A and 3B, the inner surface of the cover 15 has a recess 151, and the upper housing 11 correspondingly has a hook 121 such that the hook 121 can enter and engage the recess 151 when the carrier 16 is fully inserted into the opening 113. When the hook 121 is released from the recess 151, a user may replace the batteries 17 on the carrier 16 by drawing out the power-supply module from the opening 113 as if pulling out a drawer.

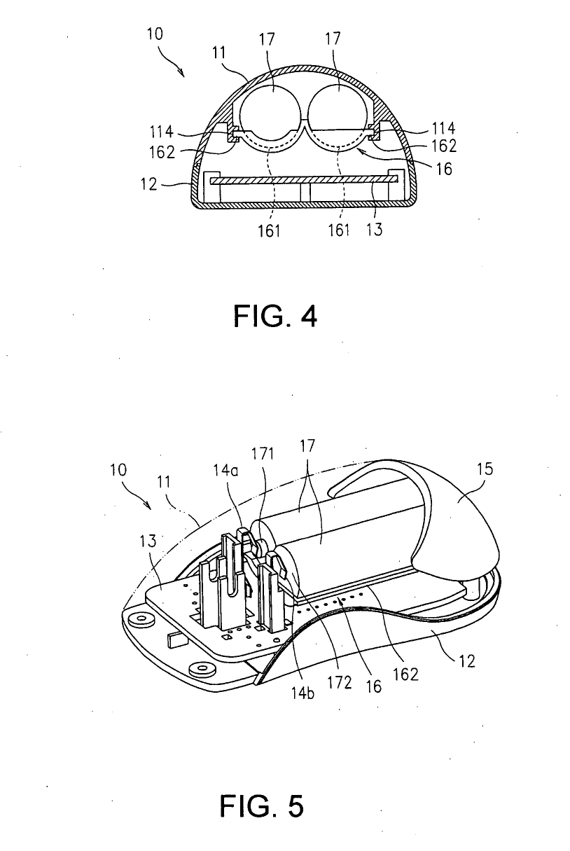

Please refer to FIGS. 2-5. The carrier 16 has grooves 161 for containing batteries 17. Metal plates 14c and 14d are respectively located within recesses 163, located between the cover 15 and carrier 16, so as to cause electrical contact with battery poles 171 and 172. The carrier 16 has two parallel flanges 162 at each side which can be inserted into corresponding grooves 114.

By the structure mentioned above, the advantages of the present invention can be listed below:
1. A strengthened upper housing.
2. Simplified replacement of the battery.
3. Reduced main body size.

While the description above refers to particular embodiments of the present invention, it will be understood that many modifications may be made without departing from the spirit thereof. The accompanying claims are intended to cover such modifications as would fall within the true scope and spirit of the present invention.

1. A wireless pointing device, comprising
a body having an opening; and
a power-supply module;
wherein the power-supply module is arranged to carry at least one battery; to be inserted into the opening in order to supply power from said battery to said pointing device, and to be drawn out from the opening for replacement of the battery.

2. The pointing device as claimed in claim 1, wherein the body has a circuit board, and a least a metal plate extending from the circuit board for electrically contacting the battery.

3. The pointing device as claimed in claim 1, wherein the power-supply module has a carrier for containing the battery;
each of the side of the carrier having a flange, and correspondingly each side of the opening having a groove for receiving the flange.

4. The pointing device as claimed in claim 1, wherein the power-supply module is fixed to the body by a fixing device.

5. The pointing device as claimed in claim 1, wherein the fixing device includes a hook located on the body, and a recess correspondingly located on the power-supplying module.

6. The pointing device as claimed in claim 1, wherein the pointing device is a computer mouse or trackball.

7. The pointing device as claimed in claim 1, wherein the pointing device is a wireless input device.

8. The pointing device as claimed in claim 7, wherein the input device is a game controller.
